(19) United States
(12) Patent Application Publication
(10) Pub. No.: US 2014/0284960 A1
(43) Pub. Date: Sep. 25, 2014

(54) WASHABLE VEHICLE COVER SYSTEMS

(71) Applicant: Alice Chang, South Pasadena, CA (US)

(72) Inventor: Alice Chang, South Pasadena, CA (US)

(21) Appl. No.: 13/939,548

(22) Filed: Jul. 11, 2013

Related U.S. Application Data
(60) Provisional application No. 61/804,303, filed on Mar. 22, 2013.

(51) Int. Cl. B60J 11/04

(52) U.S. Cl. CPC B60J 11/04
USPC 296/136.13

(57) ABSTRACT

The washable vehicle cover protects the vehicle from sun, rain, snow, dust, dirt, and bird droppings. Once the vehicle cover gets soiled from the elements, a user may wash, dry, and reuse the vehicle cover. The washable vehicle cover can have a variety of shapes, such as oval egg shape, rectangular shape, cylindrical shape, cubical shape, or the like, in order to fit vehicles of different shapes. The washable vehicle cover may be available in small, medium, and large sizes in order to accommodate different sized vehicles such as compact cars and full size SUVs. The vehicle (automobile) can include vehicles that do not travel on land and land vehicles. Vehicles that do not travel on land include aircraft, hovercraft, spacecraft, watercraft and sailcraft. Land vehicles may be wheeled, tracked, railed and skied, including bicycle, scooter, motorcycle, car, van, truck, van, train, bus, snowmobile, or the like.

### CROSS-REFERENCE TO RELATED APPLICATION

The present application is related to and claims priority from prior provisional application Ser. No. 61/804,303, filed Mar. 22, 2013 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of vehicle covers and more specifically relates to washable vehicle cover systems.

2. Description of the Related Art

Many individuals drive vehicles in modern society. Vehicles may include cars; trucks; bikes (motorized and non-motorized versions); buses; vans; boats; airplanes; snowmobile; and the like. When a vehicle is parked outside during undesirable weather conditions, the vehicle may be affected and/or damaged by the elements such as rain, snow, hail, or sleet, for example. Snow and ice may be difficult to remove. The sun may also cause damage to the vehicle's interior and exterior. This may cause a loss in value of the vehicle which is undesirable. When a vehicle is parked indoors for a long period of time, dust and dirt can accumulate. A reliable solution is desirable such that after being soiled by environmental elements the vehicle cover may be washed in washing machine and dried in drying machine.

Various attempts have been made to solve the above-mentioned problems such as those found in U.S. patent and U.S. Publication Nos. U.S. Pat. No. 5,188,417 to Donald B. Curchod; U.S. Publication No. 2005/0121937 to Bryan Hudgins; U.S. Pat. No. 5,800,006 to William Dean Pettigrew; U.S. Publication No. 2008/0110538 to Ioannis Varonos et al; U.S. Pat. No. 4,858,985 to Leszek Wojcik; and U.S. Pat. No. 4,795,207 to Edwin B. Clarke. This art is representative of vehicle covers. None of the above inventions and patents, taken either singly or in combination, is seen to describe the invention as claimed.

Ideally, a washable vehicle cover system should provide protection for vehicles and, yet would operate reliably and be manufactured at a modest expense. Thus, a need exists for a reliable washable vehicle cover system to avoid the above-mentioned problems.

### BRIEF SUMMARY OF THE INVENTION

In view of the foregoing disadvantages inherent in the known vehicle cover art, the present invention provides a novel washable vehicle cover system. The general purpose of the present invention, which will be described subsequently in greater detail is to provide convenient and easy-to-use protection for vehicles from environmental conditions. The present invention is a washable vehicle cover, so that the vehicle cover can be washed and dried, and is reusable.

A washable vehicle cover system is disclosed herein, in a preferred embodiment, comprising: a washable vehicle cover assembly including a washable cover having; a top side; and a bottom side; a drawstring assembly having; at least one cord-sleeve with at least one opening slit; at least one cord; and at least one fastener; wherein the washable vehicle cover system comprises the washable vehicle cover assembly. The washable vehicle cover assembly comprises in combination the washable cover and the drawstring assembly.

The parameters of the washable cover are defined by the top side and the bottom side which are preferably integral with one another in back-to-back positioning. The washable vehicle cover covers the entire vehicle, except the underside of the vehicle which is facing the ground and the wheels, may be uncovered, partially covered, or fully covered. The washable vehicle cover may extend a number of inches, such as about 0 to 10 inches, beyond the vehicle. The washable cover comprises a reflective white top side to reflect sun rays to minimize heat damage and retention as well as isolate the vehicle from the sun's harmful rays. A thickness of the washable cover does not exceed 2 millimeters in preferred embodiments such that the washable cover is easily foldable (for packing) and is suitably flexible in nature during use and non-use conditions.

The cord(s) is substantially enclosed in the cord-sleeve; the cord-sleeve allowing the at least one cord to be located around a periphery of the washable cover; wherein the cord-sleeve may be located between the top side and the bottom side. The cord-sleeve can be created by rolling the edge of the vehicle cover and sewing stitches in place. The width of the cord sleeve is slightly wider than the width of the cord, so that the cord can be inserted into the cord-sleeve.

When the washable vehicle cover assembly is installed on a vehicle it occupies a positioning adjacent and about an exterior of the vehicle. The cord-sleeve comprises a position near a bottom of the vehicle (nearest the ground surface). The opening slit(s) allows the at least one cord to be accessed to manipulate the cord(s) for tightening and loosening the washable vehicle cover in relation to the vehicle. The drawstring assembly may comprise in combination the at least one cord and the at least one fastener; wherein the at least one fastener is used to fasten the at least one cord to form pseudo continuous length sufficient to removably attach the washable vehicle cover about the vehicle.

The washable vehicle cover assembly comprises material which may be natural or synthetic. Natural material includes cotton, linen, silk, wool, flax, rubber, and the like. Synthetic material includes polyester, nylon, acrylic, aramid, olefin, ingeo, lurex, Gore-tex, plastic, bio-plastic, and the like. The material can be coated and/or waxed. The material can be washed in the washing machine and dried in the drying machine. Washable and dryable material may comprise biodegradable materials. The washable vehicle cover assembly when manufactured is able to be packaged in a compressed folded profile. As such, the washable vehicle cover assembly is useful for protecting the exterior of the vehicle; the washable vehicle cover assembly being washable and dryable in nature is reusable. The washable vehicle cover may comprise advertisements, prints, logos, trademarks, figures, drawings, writings, and so on.

A method of using a washable vehicle cover system is also disclosed herein comprising the steps of: installing a washable vehicle cover assembly about a vehicle; and tying (or otherwise attaching) at least one cord to itself to anchor the washable vehicle cover assembly to the vehicle. The method may further comprise the step of washing and drying of the washable vehicle cover assembly after the at least one use.

The present invention holds significant improvements and serves as a washable vehicle cover system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, washable vehicle cover system, constructed and operative according to the teachings of the present invention.

FIG. 1 shows a perspective view illustrating a washable vehicle cover system in an in-use condition according to an embodiment of the present invention.

FIG. 2 is a side view illustrating a washable vehicle cover assembly as installable onto a vehicle (car) according to an embodiment of the present invention of FIG. 1.

FIG. 3 is a perspective view illustrating the washable vehicle cover assembly as installable onto a vehicle (bike) according to an embodiment of the present invention of FIG. 1.

FIG. 4 is a perspective view illustrating washable vehicle cover assembly as installable onto a non-land vehicle (boat) according to an embodiment of the present invention of FIG. 1.

FIG. 5 is a flowchart illustrating a method of use for the washable vehicle cover system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a covering means for use with vehicles and more particularly to a washable vehicle cover system as used to improve the protection of vehicles.

Generally speaking, the vehicle cover of the present invention protects the vehicle from sun, rain, snow, dust, dirt, and bird droppings. Since the vehicle cover is washable, once the vehicle cover gets soiled from the elements, the vehicle cover may be washed in washing machine and dried in drying machine. By creating a low cost washable vehicle cover, the vehicle owner can have the convenience to wash, dry, and reuse the vehicle cover. The washable vehicle cover can have a variety of shapes, such as oval egg shape, rectangular shape, cylindrical shape, cubical shape, or the like, in order to fit vehicles of different shapes. The washable vehicle cover is preferably available in small, medium, and large sizes in order to accommodate different sized vehicles such as compact cars and full size SUVs. The vehicle (automobile) can include vehicles that do not travel on land and land vehicles. Vehicles that do not travel on land include aircraft, hovercraft, spacecraft, watercraft and sailcraft. Land vehicles include vehicles that are wheeled, tracked, railed and skied, including bicycle, scooter, motorcycle, car, van, truck, van, train, bus, snowmobile, or the like.

The washable vehicle cover is preferably secured to a vehicle via at least one drawstring. The drawstring is located around a periphery of the vehicle cover (nearest the bottom when in use) in a cord-sleeve. The cord-sleeve can be created by rolling the edge of the vehicle cover and sewing stitches in place. The width of the cord sleeve is slightly wider than the width of the cord, so that the cord can be inserted into the cord-sleeve. The enclosed drawstring at the edge of the cover can be let out to tie at one or more openings. The tie can occur at one slit opening at the edge of the cover. The slit opening and tie can occur at the front or the back of the vehicle with one piece of drawstring being used for a singular tie.

Further, in optional embodiments both sides of the vehicle can have a slit opening at the edge of the cover, and the tie can occur at both sides of the vehicle. Fasteners may or may not be incorporated to facilitate ease of tying or otherwise removably fastening the device securely in place. When the slit opening is at both sides of the vehicle, the enclosed drawstring can extend from the front and the back of the vehicle to the side of the vehicle to be tied at both sides of the vehicle with four pieces of enclosed drawstrings are used to make two ties at both sides of the vehicle. The length of the drawstring that is let out at the slit opening is preferably about ½ to 2 foot. The total length of the drawstring is a few feet longer than the perimeter of the cover, such as about 1 to 8 feet longer than the perimeter of the cover in preferred embodiments. The enclosed drawstring may have a width of about ½ to 2 centimeters. Additional strings can be available to tie the washable vehicle cover to the body of the vehicle.

In an alternate embodiment, the washable vehicle cover can also be tied to the vehicle by using an elastic rubber band sewn to the edge of the cover, so that the washable vehicle cover is ‘elastically’ fitted to the vehicle. The length of the elastic rubber band in these embodiments is a little shorter than the perimeter of the cover, such as about 1 to 4 feet shorter than the perimeter of the cover. The elastic rubber band has a width of about ½ to 2 centimeters, and can be glued to the edge of the cover by adhesive. Alternate embodiments may use adhesive tapes to ‘tape’ (removably adhere) the washable vehicle cover to the vehicle. The adhesive tapes can also be used to tape the loose edges, if any. The washable vehicle cover system comprises an adhesive tape at the edge of said washable vehicle cover.

The washable vehicle cover, including the drawstrings and additional strings, are preferably manufactured from a thin layer of cloth or fabric, which can be made from natural or synthetic materials. Natural material includes cotton, linen, silk, wool, flax, rubber, and the like. Synthetic material includes polyester, nylon, acrylic, aramid, olefin, ingeo, lurex, Gore-tex, plastic, bio-plastic, and the like. The material can be coated and/or waxed. Washable and dryable material may comprise biodegradable materials. An example is a washable vehicle cover made from a thin layer of nylon. The material used can be washed and dried after use, making the present invention environmentally-friendly. The washable vehicle cover covers the entire vehicle, except the underside of the vehicle which is facing the ground and the wheels, may be uncovered, partially covered, or fully covered. The washable vehicle cover may extend a number of inches, such as about 0 to 10 inches, beyond the vehicle. The thickness of the washable vehicle cover can be about ½ to 2 millimeters in thickness. The washable vehicle cover can have a reflective white or silver color in order to protect the vehicle from the sun; however other colors may be used. The washable vehicle cover can also display advertisements, prints, logos, trademarks, figures, drawings, writings, and so on.

The washable vehicle cover can comprise custom shapes made for specific models of the vehicle, and may be available for sale at vehicle and automobile dealerships and service departments. The washable vehicle cover can also be shaped as (universal) one-size-fits-all. The washable vehicle cover can be folded and packaged individually in a bag, and alternately they can be packaged as multiple packs in a bag or a box.

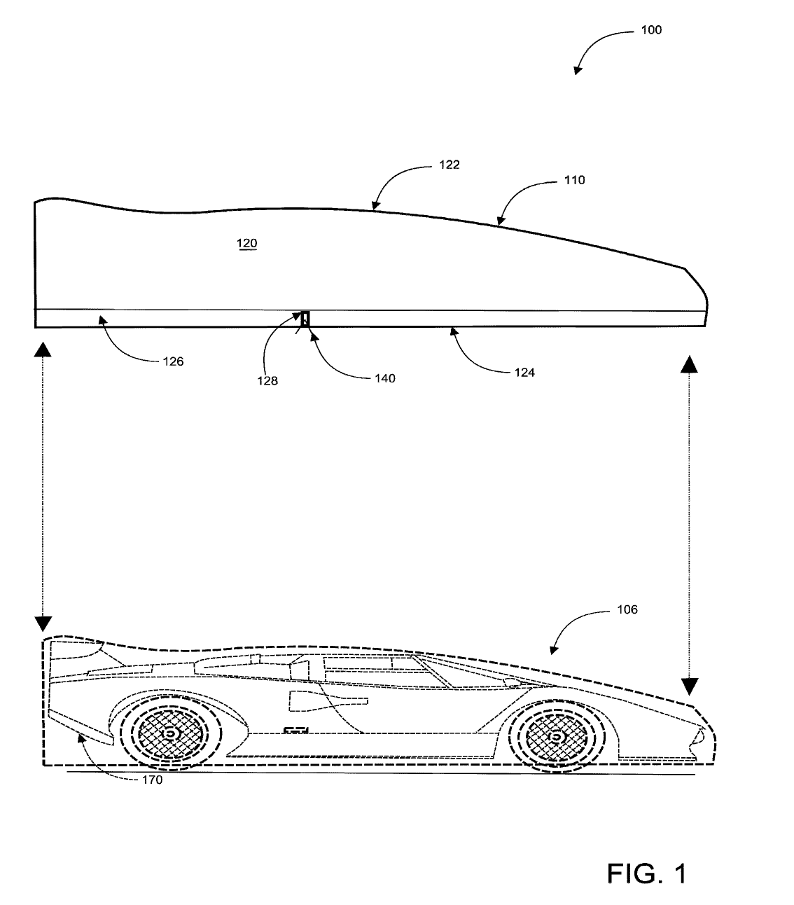

Referring to the drawings by numerals of reference there is shown in FIG. 1, a perspective view illustrating washable vehicle cover system 100 in in-use condition 150 according to an embodiment of the present invention.

Washable vehicle cover system 100 comprises washable vehicle cover assembly 110 including washable cover 120 (having top side 122 and bottom side 124 surfaces); drawstring assembly 140 having at least one cord-sleeve 126 with at least one opening slit 128; at least one cord 142; and preferably at least one fastener 144. Fastener 144 may comprise a fastening device such as a clip, cord lock or the like. Fastening means may alternately comprise tying the ends of cord 142 together.

Washable vehicle cover system 100, as mentioned comprises washable vehicle cover assembly 110; and washable vehicle cover 110 assembly comprises in combination washable cover 120 and drawstring assembly 110. The parameters of washable cover 120 are defined by top side 122 and bottom side 124; top side 122 and bottom side 124 together (or integral with each other) comprising a thickness to provide isolation means to protect vehicle 170 from the elements.

At least one cord 142 is substantially enclosed in cord-sleeve 126; cord-sleeve 126 allowing at least one cord 142 to be located around a periphery of washable cover 120; wherein cord-sleeve 126 is located between top side 122 and bottom side 124 in preferred embodiments. The cord-sleeve 126 is created by rolling the edge of washable vehicle cover 120 and sewing stitches in place. When washable vehicle cover assembly 110 is installed on vehicle 170 it occupies a positioning adjacent and about an exterior of vehicle 170; cord-sleeve 126 comprising a position near a bottom of the vehicle 170. In this way the securing means is most efficient with a lowered center of gravity.

Opening slit 128 allows at least one cord 142 to be accessed to manipulate the at least one cord 142 for tightening and loosening washable cover 120 in relation to vehicle 170. Drawstring assembly 140 comprises in combination the at least one cord 142 and at least one fastener 144. Other embodiments may not use fastener(s) 144, as previously mentioned. At least one fastener 144 is used to fasten the at least one cord 142 to form a pseudo continuous length sufficient to removably attach washable cover 120 about vehicle 170. Washable vehicle cover assembly 110 comprises washable and dryable material. The at least one cord 142 comprises washable and dryable material. In certain embodiments at least one cord 142 may be retractable. Cord-sleeve 126 may comprise at least two opening slits 128. Opening slits 128 are able to be positioned one on each side of vehicle 170 for ease of access for tightening and loosening cord 142.

Washable vehicle cover assembly 110 is useful for protecting the exterior of vehicle 170; washable vehicle cover assembly 110 being washable, dryable, and reusable. Washable vehicle cover assembly 110 is machine washable and machine dryable.

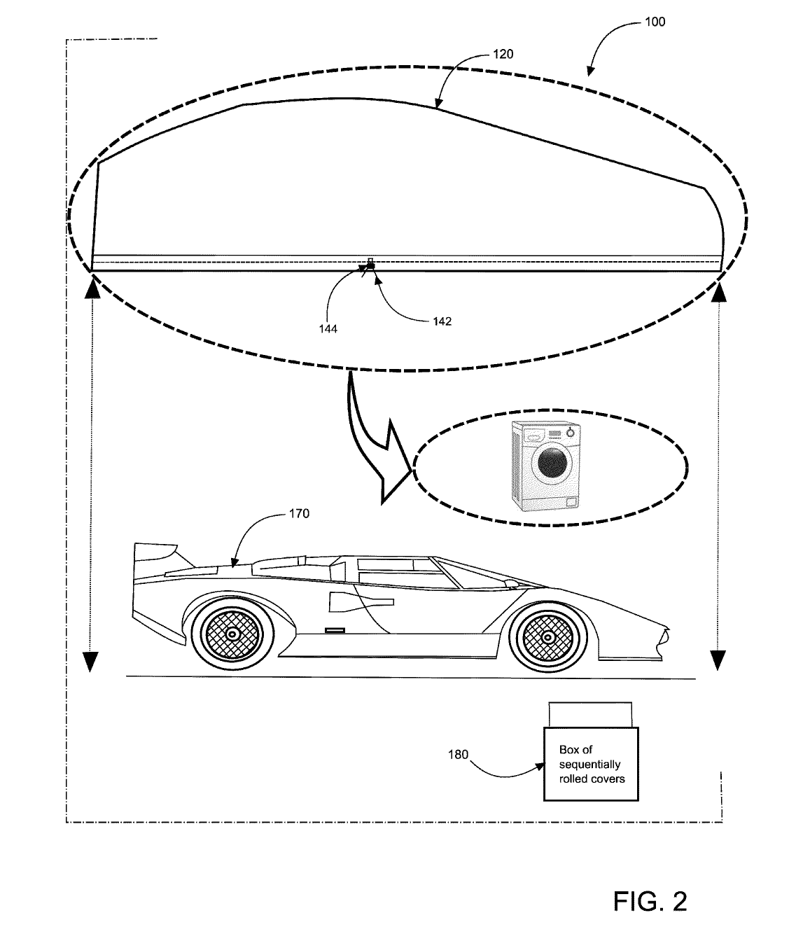

Referring now to FIG. 2, a side view illustrating washable vehicle cover assembly 110 as installable onto vehicle 170 (car) according to an embodiment of the present invention of FIG. 1.

Washable vehicle cover assembly 110 when manufactured is able to be packaged in a compressed folded profile such that they can be individually dispensed from bag 180. A thickness of washable vehicle cover 120 does not exceed 2 millimeters such that washable cover 120 is easily foldable and packaged.

In certain embodiments, washable vehicle cover system 100 comprises an elastic rubber band sewn to the edge of the cover. Alternately, adhesive tapes may be used to provide fastening means between vehicle 170 and washable vehicle cover assembly 110.

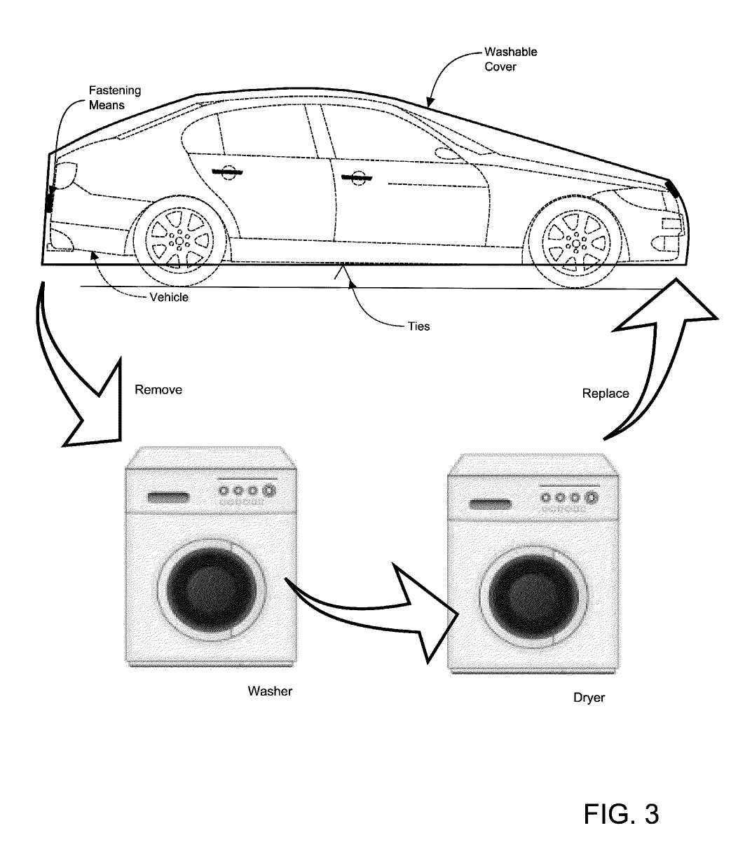

Washable cover 120 preferably comprises a reflective white top side (top side 122) to minimize heat transfer to vehicle 170 keeping vehicle 170 cooler during storage. Alternately, washable cover 120 comprises a reflective silver top side (top side 122). Vehicle 170 comprises a car in the embodiment shown. Vehicle 170 comprises a truck in embodiments not shown. Vehicle 170 may comprise a two wheeled version of vehicle 170, as shown in FIG. 3.

Referring now to FIG. 3, a perspective view illustrating washable vehicle cover assembly 110 as installable onto vehicle 170 (bike) according to an embodiment of the present invention of FIG. 1. Vehicle 170 may comprise a two wheeled version of vehicle 170 which may be motorized (motorcycle) or non-motorized (bicycle).

Washable and dryable material preferably comprises natural and synthetic materials. Natural material includes cotton, linen, silk, wool, flax, rubber, and the like. Synthetic material includes polyester, nylon, acrylic, aramid, olefin, ingeo, lurex, Gore-tex, plastic, bio-plastic, and the like. The material can be coated and/or waxed. Washable and dryable material may comprise biodegradable materials. Upon reading this specification, it should be appreciated that, under appropriate circumstances, considering such issues as user preferences, design preference, structural requirements, marketing preferences, cost, available materials, technological advances, etc., may be sufficient.

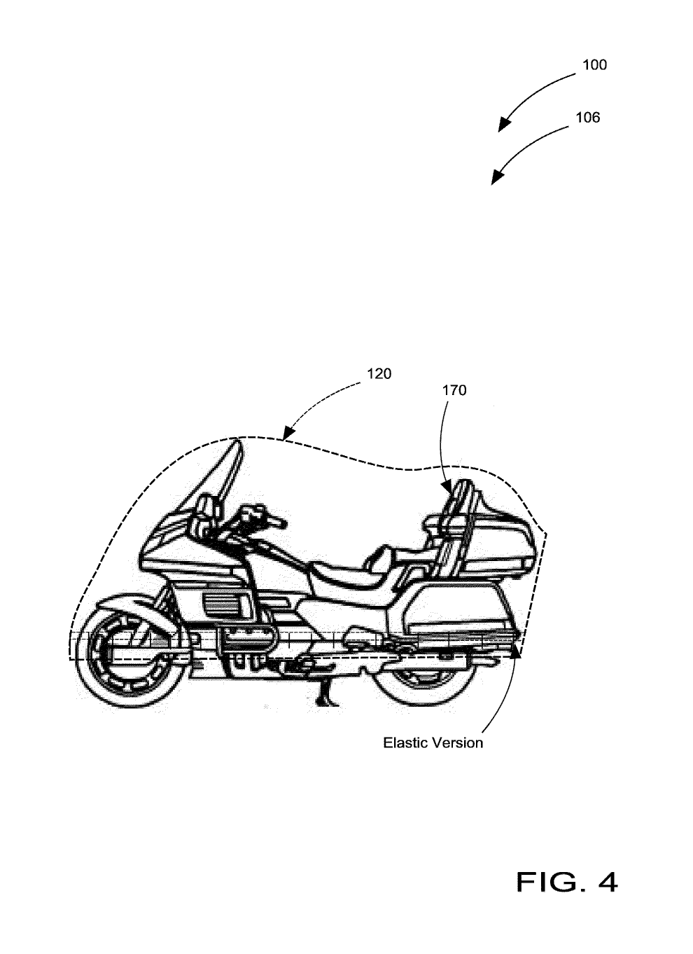

Referring now to FIG. 4, a perspective view illustrating washable vehicle cover assembly 110 as installable onto a non-land version of vehicle 170 (boat) according to an embodiment of the present invention of FIG. 1.

Adhesive tapes may be used to provide fastening means between vehicle 170 and washable vehicle cover assembly 110. As shown, vehicle 170 may comprise non-land version of vehicles 170 including aircraft, hovercraft, spacecraft, watercraft and sailcraft, such as boats, airplanes, or the like. Washable vehicle cover system 100 may be sold as kit 440 comprising the following parts: at least one washable vehicle cover assembly 110; bag 180; at least one fastener 144; and at least one set of user instructions. Washable vehicle cover system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different covers and combinations thereof, parts may be sold separately, etc., may be sufficient.

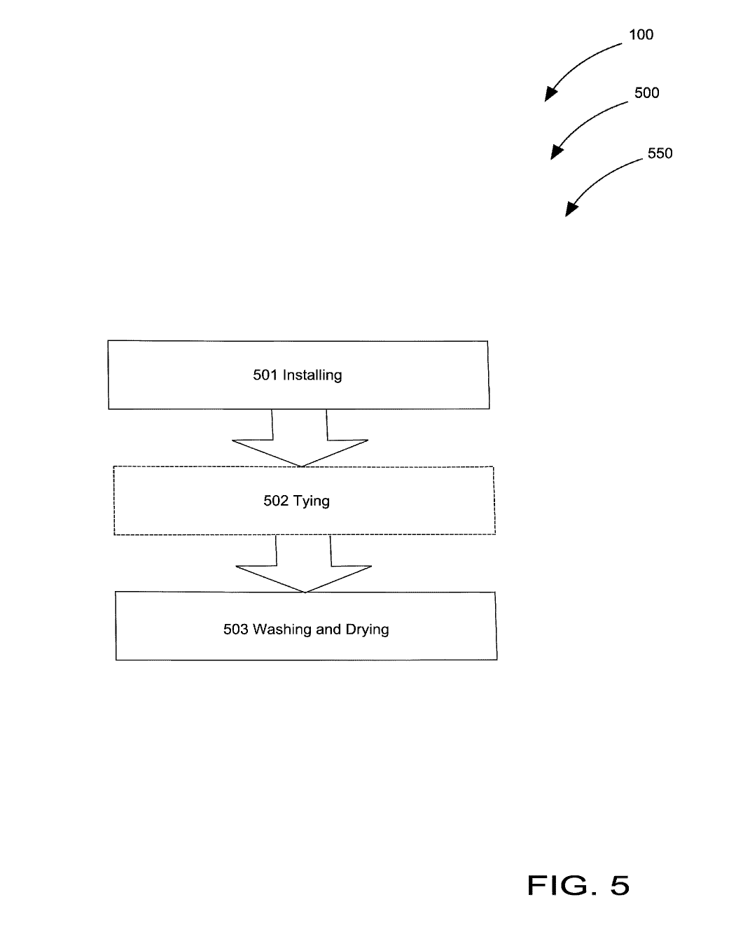

Referring now to FIG. 5, a flowchart 550 illustrating a method of use 500 for washable vehicle cover system 100 according to an embodiment of the present invention of FIGS. 1-4.

A method of using (method of use 500) a washable vehicle cover system 100 comprises the steps of: step one 501 installing washable vehicle cover assembly 110 about vehicle 170; and step two 502 tying (or otherwise attaching to vehicle 170) at least one cord 142 to itself to anchor washable vehicle cover assembly 110 to vehicle 170. The method 500 may further comprise the step three 503 of washing and drying washable vehicle cover assembly 110 after at least one use; washable vehicle cover assembly 110 comprising washable and dryable materials.

It should be noted that step two 502 is an optional step and may not be implemented in all cases such as in elastic versions. Optional steps of method 500 are illustrated using dotted lines in FIG. 5 so as to distinguish them from the other steps of method 500.

It should be noted that the steps described in the method of use can be carried out in many different orders according to user preference. The use of “step of should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A washable vehicle cover system comprising:
a washable vehicle cover assembly including;
a washable cover having;
a top side; and
a bottom side;
a drawstring assembly having;
at least one cord-sleeve with at least one opening slit;
at least one cord; and
at least one fastener;
wherein said washable vehicle cover system comprises said washable vehicle cover assembly;
wherein said washable vehicle cover assembly comprises in combination said washable cover and said drawstring assembly;
wherein parameters of said washable cover are defined by said top side and said bottom side;
wherein said at least one cord is substantially enclosed in said cord-sleeve, said cord-sleeve allowing said at least one cord to be located around a periphery of said washable cover;
wherein said cord-sleeve is located between said top side and said bottom side;
wherein said cord-sleeve is created by rolling the edge of said washable vehicle cover and sewing stitches in place;
wherein said cord-sleeve is slighter wider than the width of said at least one cord;
wherein when said washable vehicle cover assembly is installed on a vehicle it occupies a positioning adjacent and about an exterior of said vehicle, said cord-sleeve comprising a position near a bottom of said vehicle;
wherein said opening slit allows said at least one cord to be accessed to manipulate said at least one cord for tightening and loosening said disposable cover in relation to said vehicle;
wherein said drawstring assembly comprises in combination said at least one cord and said at least one fastener;
wherein said at least one fastener is used to fasten said at least one cord to form pseudo continuous length sufficient to removably attach said washable cover about said vehicle;
wherein said washable vehicle cover assembly comprises washable and dryable material; and
wherein said washable vehicle cover assembly is useful for protecting said exterior of said vehicle, said washable vehicle cover assembly being washable, dryable, and reusable.

2. The washable vehicle cover system of claim 1 wherein said washable vehicle cover assembly when manufactured is able to be packaged in a compressed folded profile such that they can be dispensed from a bag.

3. The washable vehicle cover system of claim 1 wherein said washable vehicle cover comprises an elastic rubber band sewn to an edge of said washable vehicle cover.

4. The washable vehicle cover system of claim 1 wherein said washable vehicle cover comprises an adhesive tape at an edge of said washable vehicle cover.

5. The washable vehicle cover system of claim 1 wherein said washable and dryable material is selected from the group consisting of natural and synthetic materials, including cotton, linen, silk, wool, flax, rubber, polyester, nylon, acrylic, aramid, olefin, ingeo, lurex, Gore-tex, plastic, and bio-plastic.

6. The washable vehicle cover system of claim 5 wherein said washable and dryable material is biodegradable.

7. The washable vehicle cover system of claim 1 wherein said washable vehicle cover comprises a reflective white said top side.

8. The washable vehicle cover system of claim 1 wherein said washable vehicle cover comprises an advertisement.

9. The washable vehicle cover system of claim 1 wherein material of said at least one cord is washable and dryable.

10. The washable vehicle cover system of claim 1 wherein said adhesive tapes provide fastening means between said vehicle and said washable vehicle cover assembly.

11. The washable vehicle cover system of claim 1 wherein said cord-sleeve comprises at least two said opening slits.

12. The washable vehicle cover system of claim 12 wherein said opening slits are able to be positioned one on each side of said vehicle for ease of access for tightening and loosening.

13. The washable vehicle cover system of claim 1 wherein a thickness of said washable vehicle cover does not exceed 2 millimeters such that said washable vehicle cover is easily foldable.

14. The washable vehicle cover system of claim 1 wherein said at least one cord is retractable.

15. The washable vehicle cover system of claim 1 wherein said vehicle is a non-land said vehicle which is selected from the group consisting of aircraft, hovercraft, spacecraft, watercraft, and sailcraft.

16. The washable vehicle cover system of claim 1 wherein said vehicle is a land said vehicle comprises land vehicles selected from the group consisting of wheeled, tracked, railed and skied said vehicles.

17. The washable vehicle cover system of claim 1 wherein said vehicle comprises wheeled vehicles selected from the group consisting of bicycle, scooter, motorcycle, car, van, truck and bus.

18. The washable vehicle cover system of claim 1 wherein said washable vehicle cover assembly is machine washable and machine dryable.

19. A washable vehicle cover system comprising:
a washable vehicle cover assembly including;
a washable cover having;
a top side; and
a bottom side;
a drawstring assembly having;
at least one cord-sleeve with at least one opening slit;
at least one cord; and
at least one fastener;
wherein said washable vehicle cover system comprises said washable vehicle cover assembly;
wherein said washable vehicle cover assembly comprises in combination said washable vehicle cover and said drawstring assembly;
wherein parameters of said washable vehicle cover are defined by said top side and said bottom side;
wherein said cord-sleeve is created by rolling the edge of said washable vehicle cover and sewing stitches in place;
wherein said cord-sleeve is slighter wider than the width of said at least one cord;
wherein said washable vehicle cover comprises a reflective white said top side to reflect sun rays;
wherein a thickness of said washable vehicle cover does not exceed 2 millimeters such that said washable cover is easily foldable;
wherein said at least one cord is substantially enclosed in said cord-sleeve, said cord-sleeve allowing said at least one cord to be located around a periphery of said washable vehicle cover;
wherein said cord-sleeve is located between said top side and said bottom side;
wherein when said washable vehicle cover assembly is installed on a vehicle it occupies a positioning adjacent and about an exterior of said vehicle, said cord-sleeve comprising a position near a bottom of said vehicle;
wherein said opening slit allows said at least one cord to be accessed to manipulate said at least one cord for tightening and loosening said washable vehicle cover in relation to said vehicle;
wherein said drawstring assembly comprises in combination said at least one cord and said at least one fastener;
wherein said at least one fastener is used to fasten said at least one cord to form pseudo continuous length sufficient to removably attach said washable vehicle cover about said vehicle, said fastener also comprising an adhesive and an elastic;
wherein said washable vehicle cover assembly comprises washable and dryable material;
wherein said washable and dryable material comprises synthetic material;
wherein said synthetic material is biodegradable;
wherein said at least one cord comprises washable and dryable material;
wherein said washable vehicle cover assembly when manufactured is able to be packaged in a compressed folded profile such that they can be dispensed from a bag; and
wherein said washable vehicle cover assembly is useful for protecting said exterior of said vehicle, said washable vehicle cover assembly being washable, dryable, and reusable.

20. A method of using a washable vehicle cover system comprising the steps of:
installing a washable vehicle cover assembly about a vehicle;
attaching said washable vehicle cover assembly to said vehicle; and
washing and drying of said washable vehicle cover assembly after at least one use, said washable vehicle cover assembly comprising washable and dryable materials.
